(19) United States
(12) Patent Application Publication
(10) Pub. No.: US 2006/0090429 A1
(43) Pub. Date: May 4, 2006

(54) Spinner top for an air filter

(76) Inventors: Jere James Wall, Helendale, CA (US); Steve Eugene Williams, Loma Lina, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/261,000

(22) Filed: Oct. 28, 2005

Related U.S. Application Data
(60) Provisional application No. 60/624,230, filed on Nov. 1, 2004.

(51) Int. Cl. B01D 46/00

(52) U.S. Cl. 55/418

(57) ABSTRACT

A cover is provided for an air filter that is used in automobile applications. The cover is adapted to generally fit over an air filter that has a cylindrical shape with filtering material on its top and vertical sides. The cover has a hole about its center axis that is sized to receive a screw provided on the top side of the air filter. The cover may be provided with one or more bearing mechanisms along its center to allow the cover to spin about its center axis. The cover has openings so that air may pass through the openings and into the top side of the air filter. The openings may have angled cuts, like a blade of a propeller, so that as air passes through the openings, the angle cuts cause the cover to spin relative to the air filter without inhibiting flow of air to the air filter.

### BACKGROUND OF THE INVENTION

1. Field of Invention

This invention relates to a cover that is adapted to spin on top of an air filter for an automobile.

2. Background of Invention

Air filters for vehicles such as automobiles are designed to provide a maximum amount of filtered air to the air intake system of the engine. In particular, in high performance vehicles, such as race cars and hot rods, the air filter generally sits above the engine and the air filter may be hidden underneath the hood or exposed through an opening in the hood. With hot rods or show cars, besides performance, the appearance of the car is another important consideration. In particular, the engine compartment of the car is “dressed up” to improve the overall appearance of the car. With regard to the air filter, however, not much consideration has been given to cover up the appearance of the air filter because the performance consideration has outweighed the appearance of the air filter. For example, FIG. 1 shows an air filter 10 adapted to receive air through its top side 12 and vertical side 14. The air filter 10 has a center opening 16 adapted to receive a screw to hold the air filter 10 in place on top of the air intake system of the engine (not shown). Once the air filter 10 is positioned over the air intake system of the engine, a nut may be used to tighten around the screw to hold the air filter 10 in place. The top side 12 of the air filter is generally not covered so that as much air as possible can pass through the top side 12 of the air filter 10. In some instances, a cover may be used to cover up the top side 12 of the air filter to dress up the air filter but the cover restricts air flow through the top side of the air filter. As such, there is a need to improve the appearance of the air filter without inhibiting air flow to the air filter.

### INVENTION SUMMARY

This invention is generally directed to a cover for an air filter in automobile applications. The cover is adapted to generally fit over an air filter that has a cylindrical shape with filtering material on the top side and the vertical side. The cover has a hole about its center axis that is sized to receive a screw provided on the top side of the air filter. The cover may be provided with one or more bearing mechanisms along its center to allow the cover to spin about its center axis. The cover has openings so that air may pass through the openings and into the top side of the air filter. The openings may have angled cuts, like a blade of a propeller, so that as air passes through the openings, the angle cuts cause the cover to spin relative to the air filter without inhibiting flow of air to the air filter.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 is a perspective view of an existing air filter adapted to filter air through its top side and vertical side.

FIG. 2 is a perspective view of a cover.

FIG. 3 is a top view of the cover.

FIG. 4 is a cross-sectional view of the cover of FIG. 3.

FIG. 5 is a cross-sectional view of the cover rotatably coupled to an air filter.

FIG. 6 is a perspective view of the cover rotatably coupled to an air filter.

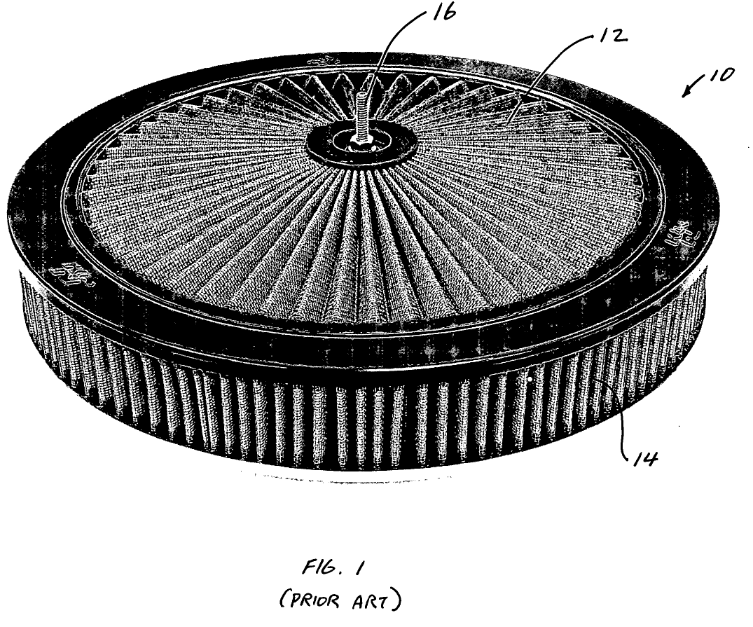

### DESCRIPTION OF THE INVENTION

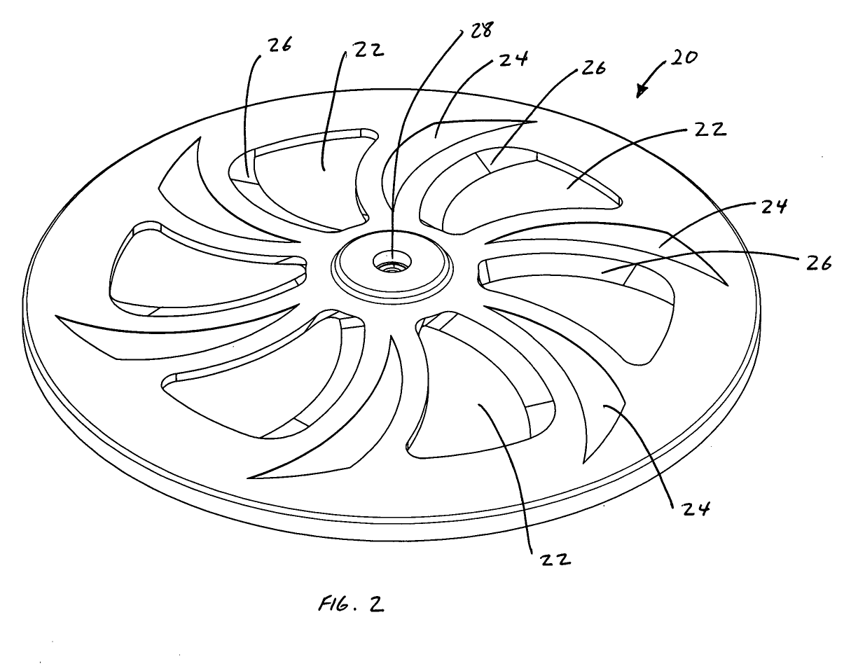

FIG. 2 is a perspective view of a cover 20 adapted to cover at least a portion of the top side 12 of the air filter 10. The cover 10 may rest on top of the air filter 10 in a substantially horizontal manner. The cover 20 has a plurality of openings 22 with ribs 24 between two adjacent openings. The outer configuration of the openings 22 may vary and the size of the opening 22 may be large enough so that the ribs 24 on the cover 20 do not inhibit air flow through the top side 12 of the air filter 10. The openings 20 may have angled cuts 26 along the edge of the openings 22 so that as air passes across the cover 20 and/or through the openings 22, the angled cuts 26 causes the cover 20 to spin about the center axis 28 of the cover 20. The angled cuts 26 may be curved and may be shaped like a blade of a propeller.

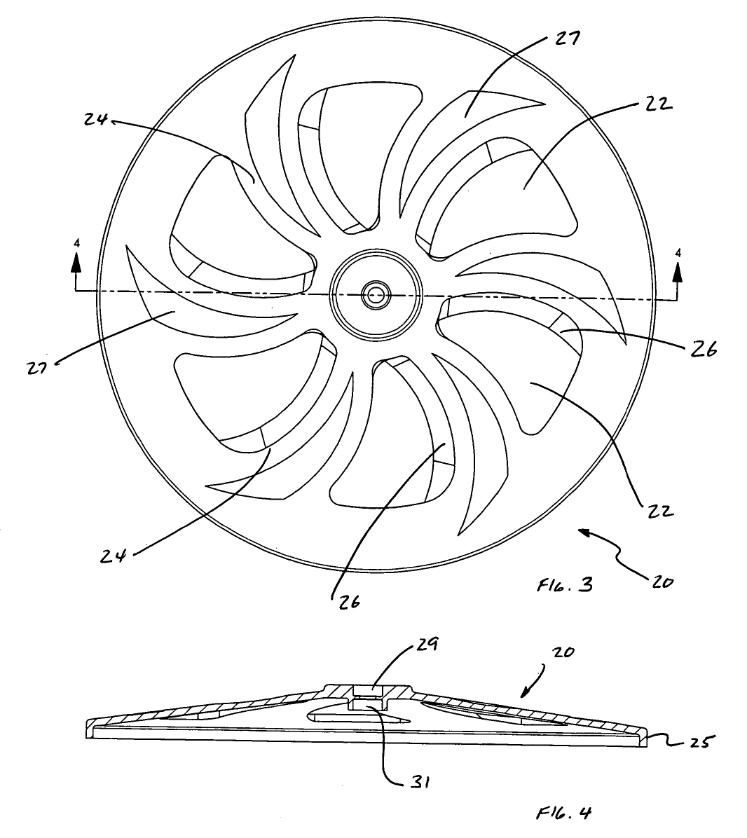

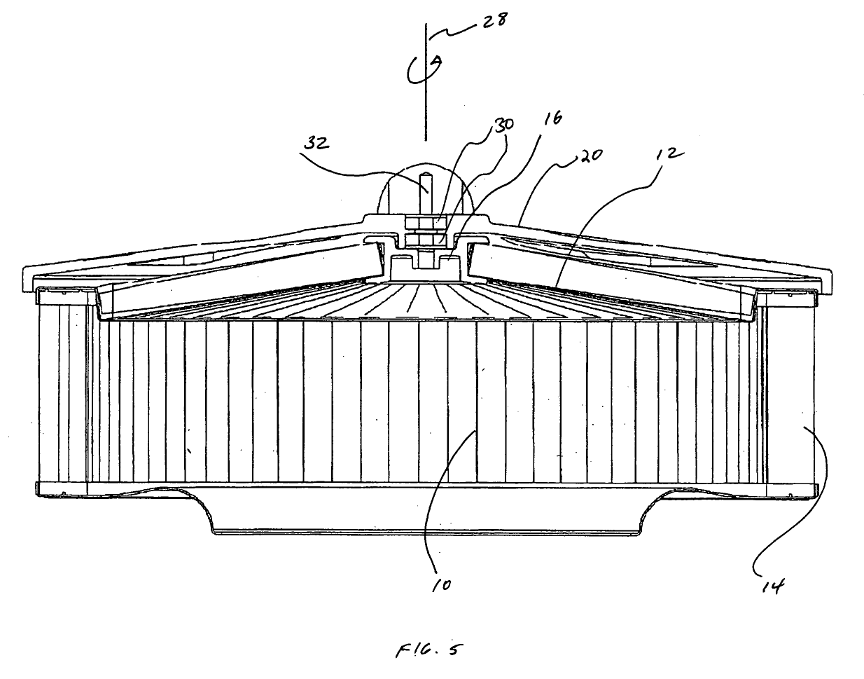

FIG. 3 is a top view of the cover 20, and FIG. 4 is a cross-sectional view of the cover 20 shown in FIG. 3 along the line 4-4. The cover 20 may have a flange 25 adapted to enclose the top side 12 of the air filter 10. Each rib 24 on the cover 20 may have a cavity cut out 27 to reduce the weight of the cover 20 and/or to add to the aesthetic look of the cover 20. Along the center of the cover 20, cavities 29 and 31 may be formed on the top and bottom sides of the cover 20, respectively. Each of the cavities 29 and 31 is adapted to receive a bearing as discussed below.

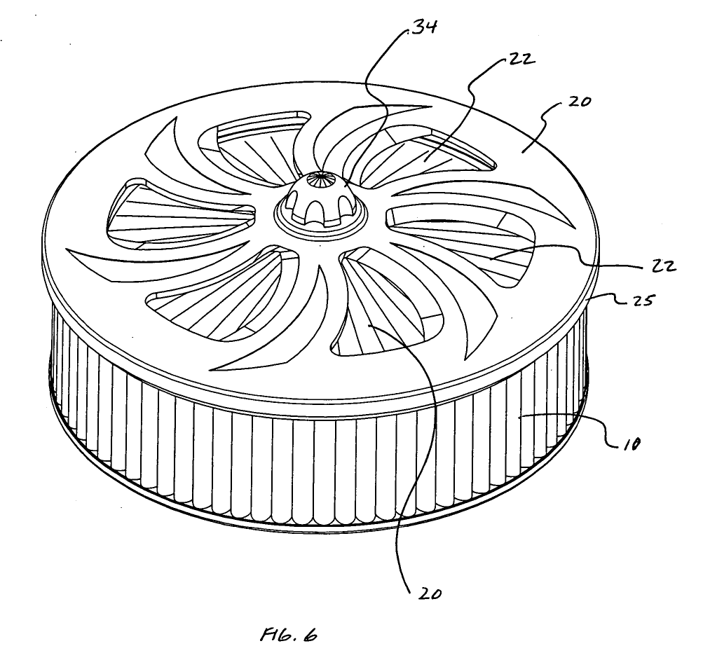

FIG. 5 is a cross-sectional view of the cover 20 rotatably coupled to the top side 12 of the air filter 10. Each of the cavities 29 and 31 has a bearing 30 adapted to spin the cover 20 relative to the air filter 10. The bearings 30 may be adapted to receive a screw 32 protruding through the center opening 16 of the air filter 10 to allow the cover 20 to spin about the center axis 28. The cover 20 may be rotated manually by a user such as spinning a roulette wheel. Alternatively, the cover 20 may be rotated by air passing across and/or through the openings 22 of the cover 20. That is, when the engine is running, the air intake system draws air in through the air filter 10, which causes the air to flow pass the openings 22 of the cover 20. As the air passes through the openings 22, the angled cuts 26 along the edges of the opening 22 act as blades on a propeller to cause the cover to rotate along the center axis 28. In addition, when the cover 20 is exposed through the hood of the car, the air passing across the angled cuts 26 of the cover 20, as the car is moving, causes the cover 20 to rotate as well. With the plurality of openings 22 within the cover 20, air may flow through the top side 12 of the air filter 20 so that the cover does not inhibit air from flowing to the top side 12 of the air filter 10, while dressing up the top side 12 of the air filter 10.

FIG. 6 is a perspective view showing the cover 20 rotatably coupled to the air filter 10. As illustrated in FIG. 6, the plurality of openings 22 allows air to enter through the top side of the air filter 10. In addition, the flange 25 may act as a skirt to cover the top side 12 of the air filter 10. The cover 20 may also incorporate a battery powered motor (not shown) within the cap 34 to rotate the cover. In addition, the cap 34 may incorporate a generator (not shown) that produces power when the cover is rotated to energize the lights (not shown) located on the ribs 24 of the cover 20. This way, as the cover 20 rotates, the lights on the cover 20 may be lit to further enhance the appearance of the cover 20. The cover 20 may be manufactured through a variety of methods. For example, the cover may be machined from a solid piece of aluminum or injection molded from a plastic material.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A cover adapted to rotate about a center axis of an air filter having a top side, the cover comprising:
a bearing along a center axis of the cover, the bearing adapted to rotate the cover along the center axis, and the cover is adapted to releasably couple to the top side of the air filter along the center axis of the cover; and
the cover having a plurality of openings, at least a portion of the openings having an angled cut adapted to rotate the cover as air passes through the openings having the angled cut.

2. The cover according to claim 1, the cover having a flange adapted to enclose the top side of the air filter.

3. The cover according to claim 1, the cover having at least one cavity adapted to house the bearing.

4. The cover according to claim 1, where the cover is mounted substantially horizontal onto the air filter.

5. A cover for an air filter of an automobile, the cover comprising:
a cover having a plurality of openings to allow air to pass therethrough and toward a top side of an air filter;
means for attaching the cover to the top side of the air filter; and
means for rotating the cover relative to the air filter.

6. The cover according to claim 5, where at least a portion of the plurality of openings have an angled cut adapted to rotate the cover as air passes through the openings having the angled cut.

7. The cover according to claim 5, where the cover is mounted substantially horizontal onto the air filter.

8. A method of covering a top side of an air filter, the method comprising:

8. A method of covering a top side of an air filter, the method comprising:
coupling a cover on the top side of the air filter;
spinning the cover relative to the air filter; and
passing air through the cover and the air filter.

9. The method according to claim 8, where the spinning of the cover is done when air passes across the cover.

10. The method according to claim 8, where the cover is coupled to the air filter in a substantially horizontal manner.
